(19) United States
(12) Patent Application Publication
(10) Pub. No.: US 2005/0197599 A1
(43) Pub. Date: Sep. 8, 2005

(54) Hanging electro-stimulating massage belt

(76) Inventor: Tsung-I Yu, Taipei (TW)

Correspondence Address: BACON & THOMAS, PLLC, 625 SLATERS LANE, FOURTH FLOOR, ALEXANDRIA, VA, 22314, US

(21) Appl. No.: 10/790,051

(22) Filed: Mar. 2, 2004

(51) Int. Cl. A61H 11/00

(52) U.S. Cl. 601/21; 601/15

(57) ABSTRACT

A hanging electro-stimulating massage belt wherein the belt is an elongated band having a single conducting area or a plurality of conducting areas of opposite polarities for covering the neck or the shoulders of a person. Two ends of the massage belt are provided with weight bags, buckles or adhesive members for stabilizing the conducting areas on human body. The massage belt is connected to a controller that sends out pulsating electric signals for providing electro-stimulating massage at low or middle pulsating frequencies.

### BACKGROUND OF THE INVENTION

(a) Field of the Invention

The present invention relates to electro-stimulating massage devices, and more particularly to a hanging electro-stimulating massage belt hanged around the neck and the shoulders of a human body for providing electro-stimulating massage at a middle or low pulsation rate.

(b) Description of the Prior Art

Office staffers, drivers or intensive computer users who have to maintain in a fixed posture for an extended time are easy to get aches and stiffness at necks and shoulders. The low-frequency pulsating health assistors of the prior art generally utilize silicon-gel electrodes attached to the neck or the shoulders of a human body and connected to a controller for providing a massage effect.

### SUMMARY OF THE INVENTION

The primary objective of the present invention is to provide a hanging electro-stimulating massage device, wherein the device is in belt form and is provided with single-polar or bipolar conducting areas, conducting buttons, a controller and mounting means selected from the group of weight bags, buckle rings and adhesive members, and whereby the massage belt can be disposed steadily on the neck or shoulders of a human body. The conducting areas therefore closely cover over the acupuncture points of the body portions to provide an effective massage.

The various objects and advantages of the present invention will be more readily understood from the following detailed description when read in conjunction with the appended drawings.

### BRIEF DESCRIPTION OF THE DRAWINGS

FIG. 1 is a perspective view of the first preferred embodiment according to the present invention, which has one conducting area.

FIG. 2 is a perspective view of the first preferred embodiment according to the present invention, with a conducting buttons connected to a controller.

FIG. 3 shows the present invention attached to the shoulders of a human body.

FIG. 4 shows the present invention attached to the neck of a human body.

FIG. 5 is a perspective view of the second preferred embodiment according to the present invention, which has two conducting areas.

FIG. 6 is a perspective view of the third preferred embodiment according to the present invention, which has two conducting areas.

FIG. 7 is a cross-sectional view of the present invention, wherein liquid-filled cushions sandwich the conducting areas.

FIG. 8 is a cross-sectional view of the present invention, wherein granule-filled cushions sandwich the conducting areas.

FIGS. 9 to 12 illustrate another preferred embodiment according to the present invention, wherein the massage belt is provided with flexible bands.

FIG. 13 shows the present invention mounted by flexible bands buckled on the waist rim of a pair of pants.

FIG. 14 shows two sets of conducting wires seamed along the flexible bands of the present invention mounted.

FIGS. 15 and 16 shows another embodiment of the present invention wherein the massage belt is provided with extended adhesive members for forming a ring structure.

FIG. 17 shows the ring-shaped preferred embodiment hanged across a shoulder and an opposite waist side of a human body.

FIG. 18 shows another preferred embodiment of the present invention forming a smaller ring for encircling the neck of a human body.

### DETAILED DESCRIPTION OF THE PREFERRED EMBODIMENTS

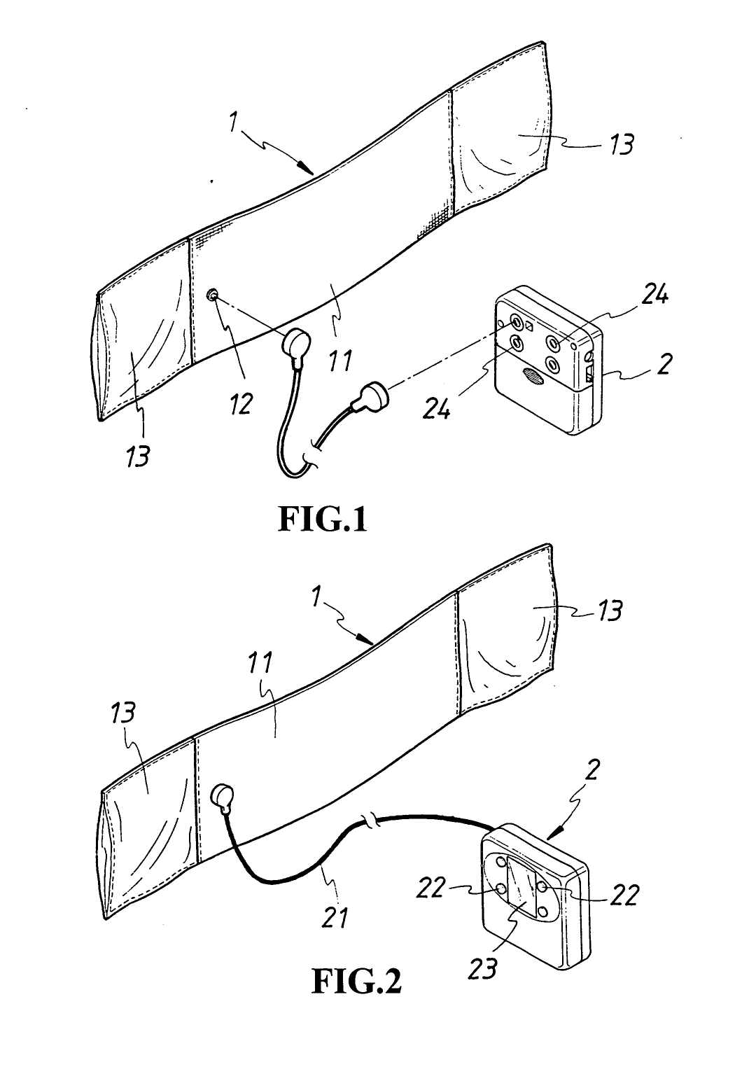

Referring to FIGS. 1 and 2, a hanging electro-stimulating massage belt 1 according to the present invention is used with a controller 2 for providing an electro-stimulating massage effect.

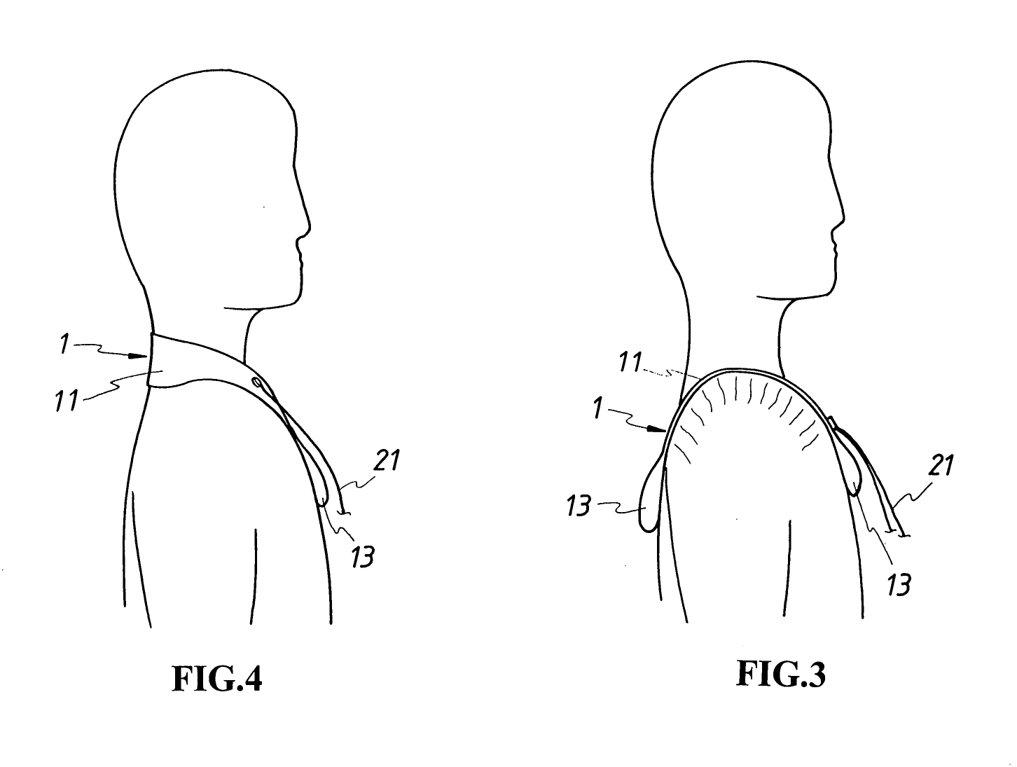

The massage belt 1 is an elongated belt body made of conducting materials so that it forms a conducting area 11 of single polarity. The conducting area 11 further includes a conducting button 12 for connecting the controller 2 through a wire 21. Each of the two ends of the massage belt 1 is provided with an insulating weight bag 13 for hanging the massage belt 1 on the shoulders or the neck of a person, as shown in FIG. 3. When the controller 2 is turned on, the controller 2, wires 21 and the conducting area 11 of the massage belt 1 form a closed electric loop so that the body portion covered by the massage belt 1 will experience pulsating electric potential and feel an electro-stimulating massage effect.

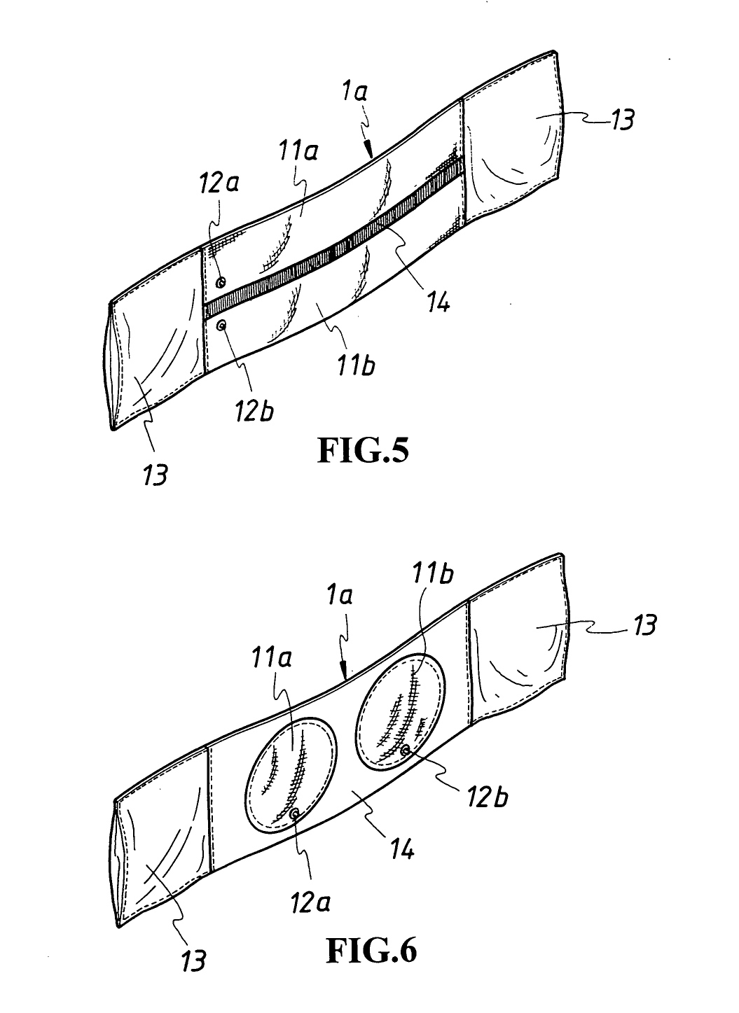

FIGS. 5 and 6 show another preferred embodiment of the present invention, wherein the massage belt 1a has two conducting areas 11a, 11b of opposite polarities, each provided with a conducting button (12a. 12b). The conducting areas 11a, 11b are divided by an insulating member 14. The weight bags 13 of the massage belt 1a stabilize the massage belt 1a on a selected body portion. When the controller 2 is turned on, one or two conducting areas 11a, 11b provide the corresponding body portion with a pulsating electric potential that activates an electro-stimulating massage effect. The shape as well as the size of the conducting areas 11a, 11b have no particular restrictions.

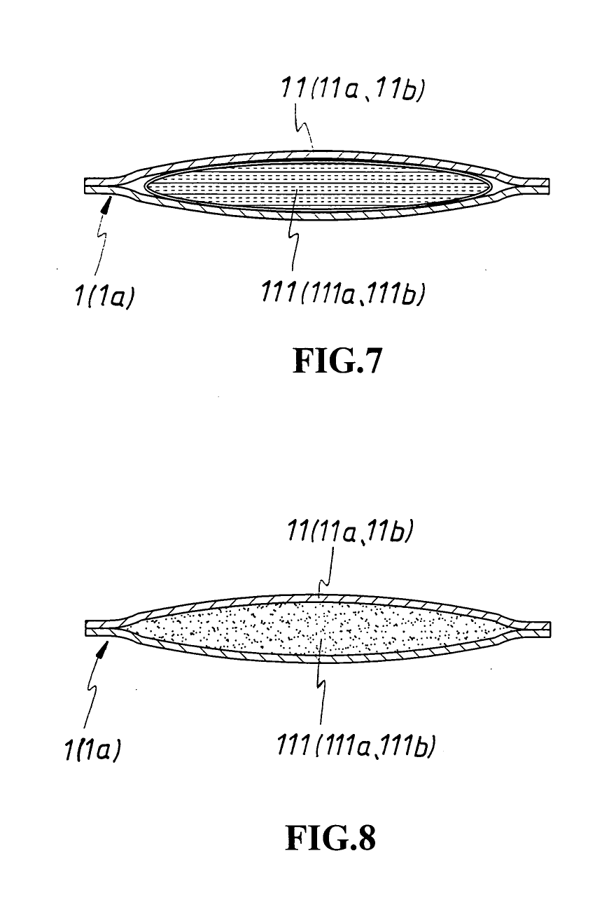

Referring FIGS. 7 and 8, the aforesaid conducting area 11 (or 11a, 11b) are provided with a cushion 111 (or a pair of cushions 111a, 111b) that is (are) stuffed with a liquid-filled object, as shown in FIG. 7, or a granule-filled object, as shown in FIG. 8, so that when the massage belt 1 or 1a is attached to a shoulder or the neck or any other selected portions of a person, the cushion 111 (or the pair of cushions 111a, 111b) will be deformed to make the person more comfortable.

The weight bags 13 at two ends of the massage belt 1 or 1a are basically insulating and can include conducting spots as needed. The weight bags 13 can be filled with sand, liquid or solid materials to acquire a suitable weight, so that the gravitational forces exerted thereon will pull the weight bags 13 downward by which the massage belt 1 contacts the body portion it is hanged on closely.

The aforesaid controller 2, as shown in FIGS. 1 and 2, includes a central integrated circuit (IC) for transmitting pulsating electric signals so as to produce high-voltage output by repeatedly charging and discharging capacitors and inductors therein. The pulse width of the output signals is program-controlled, ranging from 1 Hz to 150 Hz, so that massage of various strengths can be produced. The controller 2 is provided with a plurality of control buttons 22 for respectively adjusting the up and down of electric current, massage time, power on/off and massage modes. It further includes an LCD panel 23 for displaying the control status. The high-voltage pulsating output from the internal circuit in the controller 2 is connected to a plurality of conducting buttons 24 to form an output terminal, which can be connected to corresponding conducting buttons 12 on the massage belt 1 or 1a through wires 21 so as to form a closed loop.

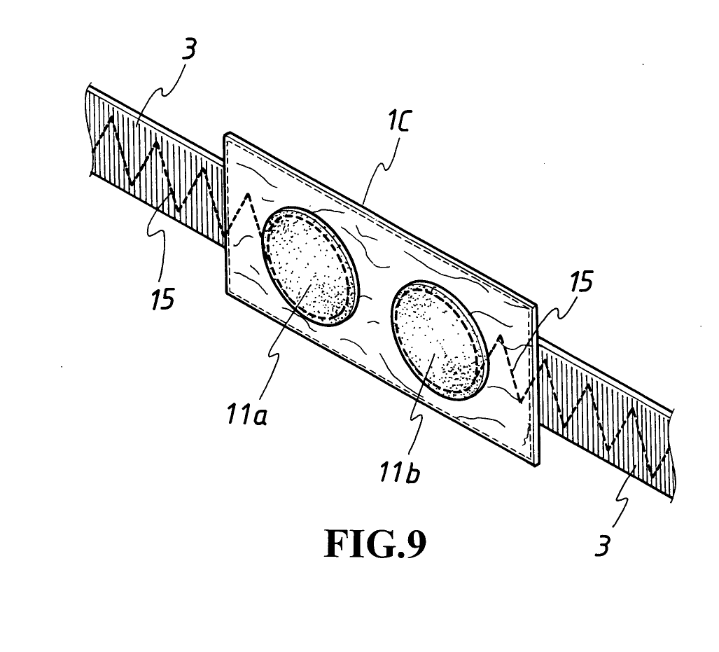

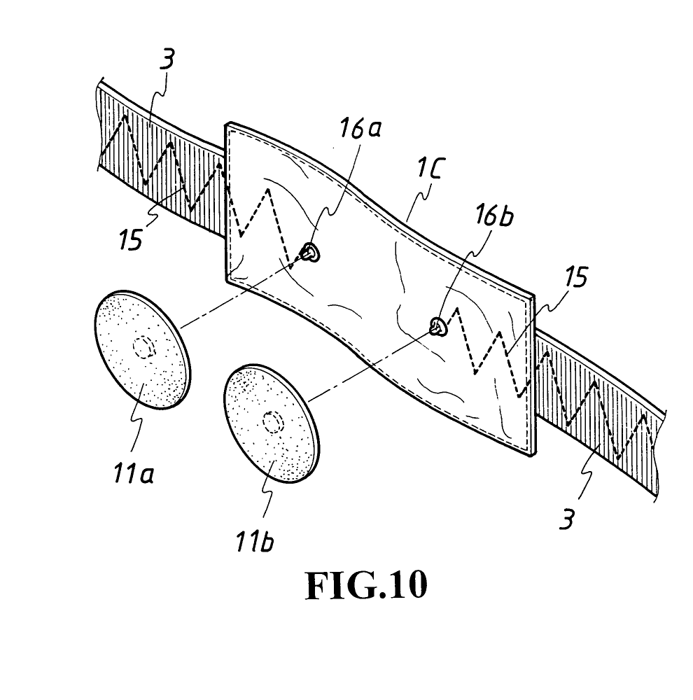

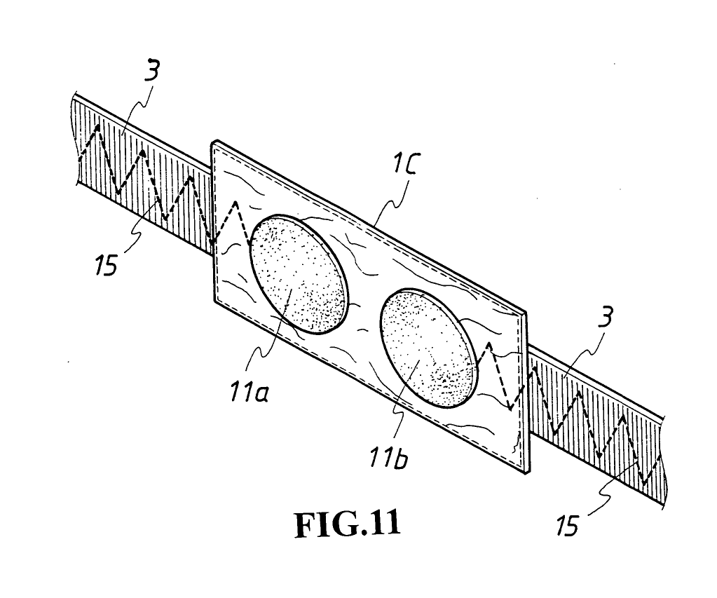

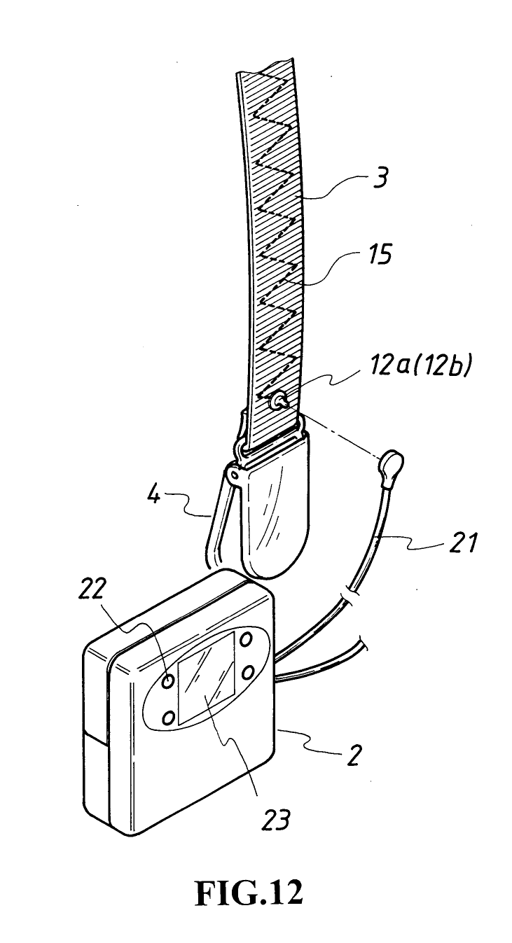

According to the present invention, the weight bags 13 of the massage belt 1 or 1a aim at improving contact of the conducting area 11 (or a pair of conducting areas 11a, 11b) with the human body. Therefore, the weight bags 13 can be replaced by other equivalent structures. For example, as shown by another preferred embodiment in FIGS. 9 to 12, two ends of a massage belt 1c are each provided with a flexible band 3. The free end of each of the flexible bands 3 is provided with a buckle 4 and a conducting button (12a, 12b). The massage belt 1c can have a single conducting area or two conducting areas 11a, 11b of opposite polarities. The conducting areas 11a, 11b and the conducting buttons 12a, 12b are connected by wires 15; the conducting buttons 12a, 12b are connected to the controller 2 through the wires 21.

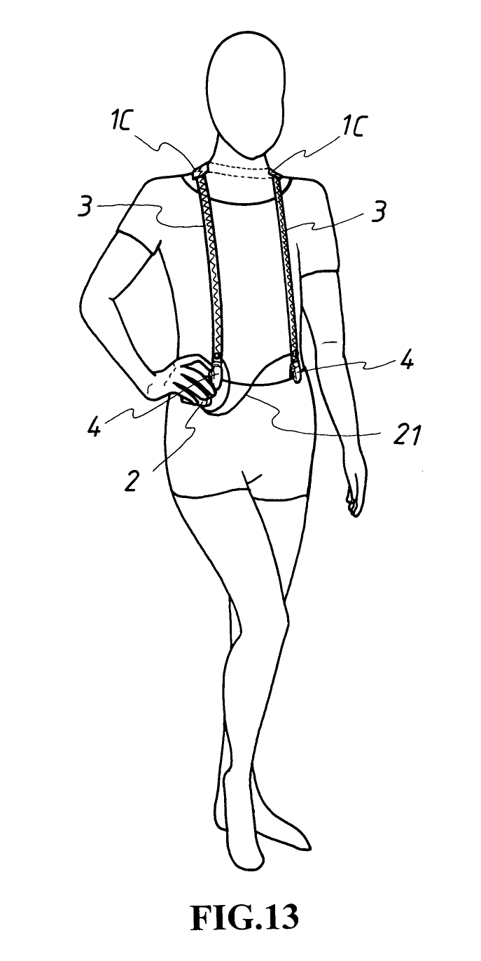

The conducting areas 11a, 11b are seamed onto the aforesaid massage belt 1c, as shown in FIG. 9. Alternatively, the conducting areas 11a, 11b can be buckled with a pair of conducting buttons 16a, 16b each connected to one end of a wire 15. The buckles 4 at ends of the flexible bands 3 are for grasping the waist rim of a pair of pants. The massage belt 1c with its flexible bands 3 connected to the pants contacts steadily with the neck and the shoulders of a human body, as shown in FIG. 13. Alternatively, the buckles 4 can be replaced by a set of adhesive members.

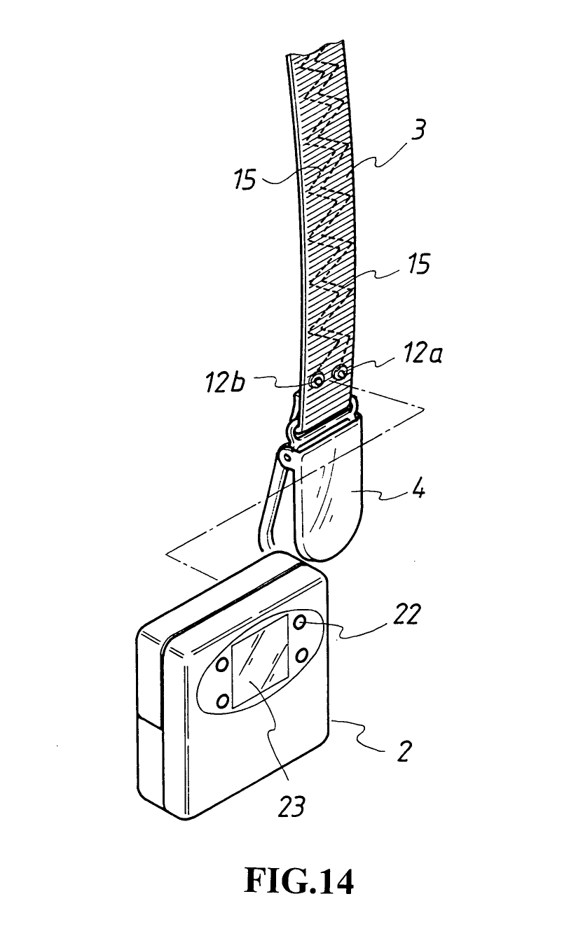

The aforesaid massage belt 1c can be provided with two or more than two pairs of conducting areas of opposite polarities, 11a and 11b, as shown in FIG. 14. Accordingly, the flexible bands 3 are each provided with two or more than two pairs of wires 15 for respectively connecting the conducting buttons 12a, 12b and the conducting areas 11a, 11b. The conducting buttons 12a, 12b are then connected to the controller 2.

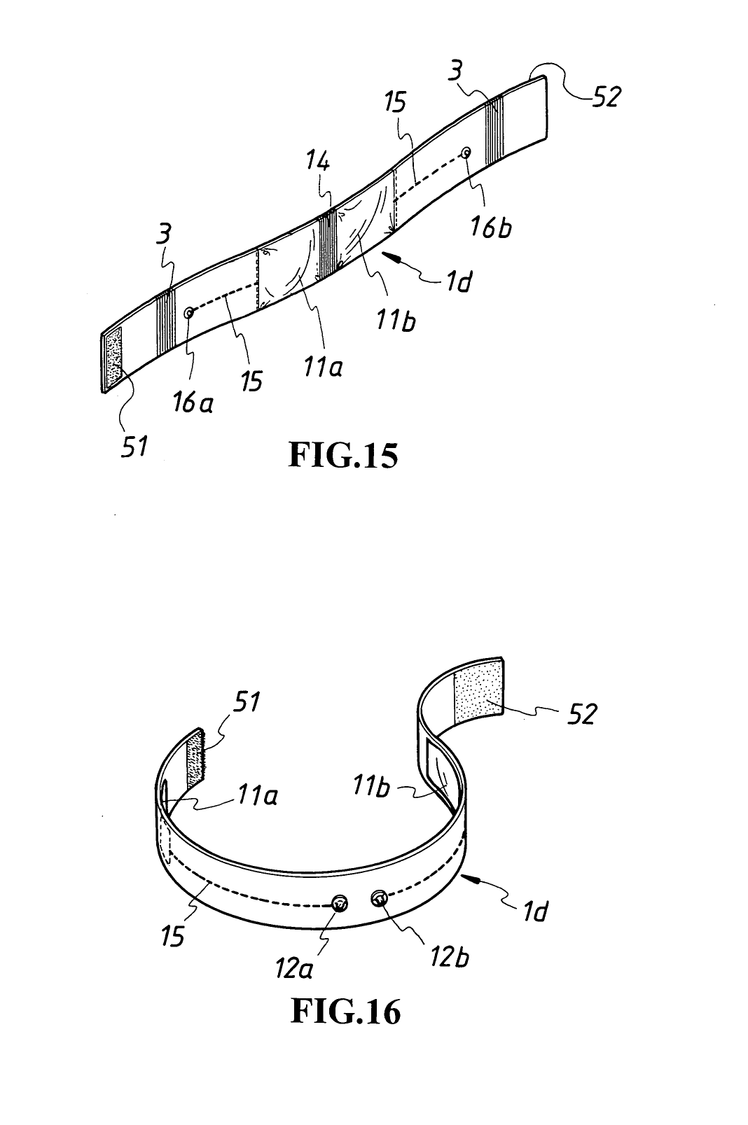

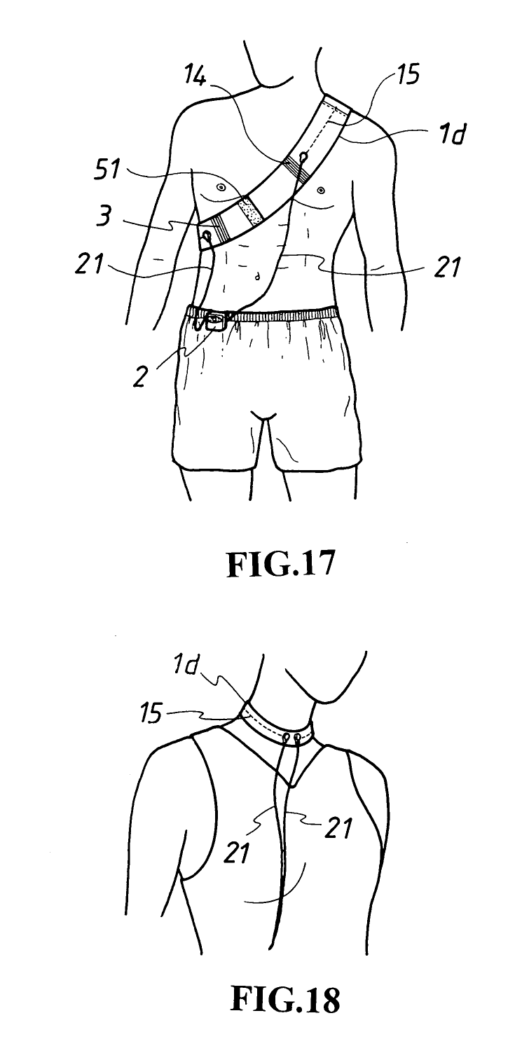

Further, two ends of the massage belt can be respectively provided with adhesive members, by which the massage belt can be self-closed to form a ring, as shown in FIGS. 15 and 16. Two ends of the massage belt 1d are provided with a pair of coupled adhesive members 51, 52. The massage belt 1d further includes conducting areas 11a, 11b, conducting buttons 12a, 12b, an insulating member 14, wires 15 and flexible bands 3. The ring-shaped msaage belt 1d thus connected can be hanged across a shoulder and an opposite waist side, as shown in FIG. 17. The massage belt lid can also form a smaller ring for hanging around the neck of a person to massage the acupuncture points on the neck.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A hanging electro-stimulating massage belt, comprising:
a massage belt of elongated band shape having a conducting portion selected from the group of a single-polarity conducting area and a plurality of conducting areas of interlaced polarities, said conducting areas converging to a conducting button; and
a pair of weight bags installed at two ends of said massage belt;
whereby said conducting button can be connected to a controller and said controller can transmits pulsating electric potential to said massage belt so as to provide an electro-stimulating massage effect.

2. The hanging electro-stimulating massage belt of claim 1 further including an insulating member dividing said conducting areas.

3. The hanging electro-stimulating massage belt of claim 1 wherein each of said conducting areas is further provided with a cushion member.

4. The hanging electro-stimulating massage belt of claim 1 wherein said weight bags are filled with a material selected from the group of sand granules, liquid and solid objects.

5. A hanging electro-stimulating massage belt, comprising:
a massage belt of elongated band shape having a conducting portion selected from the group of a single-polarity conducting area and a plurality of conducting areas of interlaced polarities, said conducting areas converging to a conducting button; and
a pair of flexible bands installed at two ends of said massage belt, free ends of said flexible bands being provided with a pair of buckles;
whereby said conducting button can be connected to a controller and said controller can transmits pulsating electric potential to said massage belt so as to provide an electro-stimulating massage effect.

6. The hanging electro-stimulating massage belt of claim 5 further including at least one set of wires, said conducting areas being connected to first ends of said wires and said conducting buttons being connected to second ends of said wires.

7. The hanging electro-stimulating massage belt of claim 5 wherein said conducting areas are separable members that can be respectively connected to a set of conducting buttons disposed at said first ends of said wires.

8. A hanging electro-stimulating massage belt, comprising:
a massage belt of elongated band shape having a conducting portion selected from the group of a single-polarity conducting area and a plurality of conducting areas of interlaced polarities, said conducting areas converging to a conducting button; and
a pair of adhesive members installed at two ends of said massage belt, said adhesive members being capable of being coupled to form a ring-shape massage belt;
whereby said conducting button can be connected to a controller and said controller can transmits pulsating electric potential to said massage belt so as to provide an electro-stimulating massage effect.

9. The hanging electro-stimulating massage belt of claim 8 wherein each of said adhesive members is connected to said massage belt through at least one section of flexible band.

10. The hanging electro-stimulating massage belt of claim 8 further including an insulating member dividing said conducting areas.

11. The hanging electro-stimulating massage belt of claim 8 further including at least one set of wires, said conducting areas being connected to first ends of said wires and said conducting buttons being connected to second ends of said wires.

12. The hanging electro-stimulating massage belt of claim 8 wherein each of said conducting areas is further provided with a cushion member.

13. The hanging electro-stimulating massage belt of claim 1 wherein said controller includes a central integrated circuit for generating pulsating electric signals so as to exciting high-voltage pulses by repeatedly charging and discharging capacitors and inductors therein; and wherein the pulse width of said high-voltage pulses is program-controllable for providing massage of various strengths at low and middle frequencies.

14. The hanging electro-stimulating massage belt of claim 13 wherein said pulse width of said high-voltage pulses produced by said controller ranges from 1 Hz to 150 Hz.

15. The hanging electro-stimulating massage belt of claim 13 wherein said high-voltage pulses produced by said controller are guided to a plurality of conducting buttons to form an output terminal.

16. The hanging electro-stimulating massage belt of claim 5 wherein said controller includes a central integrated circuit for generating pulsating electric signals so as to exciting high-voltage pulses by repeatedly charging and discharging capacitors and inductors therein; and wherein the pulse width of said high-voltage pulses is program-controllable for providing massage of various strengths at low and middle frequencies.

17. The hanging electro-stimulating massage belt of claim 16 wherein said pulse width of said high-voltage pulses produced by said controller ranges from 1 Hz to 150 Hz.

18. The hanging electro-stimulating massage belt of claim 16 wherein said high-voltage pulses produced by said controller are guided to a plurality of conducting buttons to form an output terminal.
